(19) United States
(12) Patent Application Publication
(10) Pub. No.: US 2023/0394962 A1
(43) Pub. Date: Dec. 7, 2023

(54) SYSTEMS AND METHODS FOR PREDICTIVE SAFETY ASSESSMENT

(71) Applicant: UNIVERSITY OF SOUTH FLORIDA, Tampa, FL (US)

(72) Inventor: Mouyid ISLAM, Tampa, FL (US)

(21) Appl. No.: 18/034,369

(22) PCT Filed: Oct. 28, 2021
(86) PCT No.: PCT/US2021/057040

§ 371 Date: Apr. 27, 2023

Related U.S. Application Data
(60) Provisional application No. 63/106,545, filed on Oct. 28, 2020.

(51) Int. Cl. G08G 1/01; G08G 1/16

(52) U.S. Cl. CPC G08G 1/0137; G08G 1/0125; G08G 1/164

(57) ABSTRACT

A method for generating a predictive safety assessment of at least one existing facility and at least one proposed facility includes obtaining data about an existing facility and each proposed facility, receiving user input data regarding local conditions for the existing facility and each proposed facility, determining a predicted crash frequency for the existing facility and each proposed facility based at least on a set of Safety Performance Function (SPFs) associated with a facility type for the existing facility and each proposed facility respectively, determining a conversion factor for each proposed facility based on the predicted crash frequency of the existing facility and the predicted crash frequency of each proposed facility, determining a crash severity distribution by crash types, determining an impact of local traffic volume for each proposed facility, and generating a user interface to render a graphical representation of at least each conversion factor for each proposed facility.

### CROSS-REFERENCE TO RELATED APPLICATIONS

This patent application is based on, claims priority to and incorporates by reference in its entirety U.S. Provisional Patent Application Ser. No. 63/106,545 filed on Oct. 28, 2020, entitled “Systems and Methods For Predictive Safety Assessment.”

### STATEMENT OF GOVERNMENT SUPPORT

This invention was made with government support under grant/contract number 71864-00, awarded by the U.S. Department of Transportation (DOT). The Government may have certain rights in this invention.

### BACKGROUND

Road safety management can include several different processes that involve analysis of safety including, for example, system planning, project planning and preliminary engineering, design and construction, and operations and maintenance. System planning can include identifying sites that will benefit the most from safety improvement, identifying target crash patterns for a network, and prioritizing expenditures for efficiency. Project planning and preliminary engineering can include identifying a target crash pattern for a project, evaluating the effectiveness and costs of countermeasures, and comparing the changes in crash frequency for alternatives. Design and construction can include evaluation of performance measures impacted by design changes and assessing potential changes in frequency by design exception. Operations and maintenance can include identifying crash patterns at existing locations, evaluating safety effectiveness for potential countermeasures, and modifying policies and design criteria for future planning and design. The Highway Safety Manual is a guidance document that incorporates quantitative safety analysis in roadway transportation project planning and development processes. The HSM provides information and methods for quantitatively evaluating traffic safety performance on existing and proposed roadways which may be used to inform decision making processes.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In accordance with an embodiment, a method for generating a predictive safety assessment of at least one existing facility and at least one proposed facility, the method includes obtaining (via at least one computing device) data about an existing facility. The data regarding the existing facility can include segment data and intersection data. The method further includes obtaining (via the at least one computing device) data about at least one proposed facility. The data regarding the at least one proposed facility can include segment data and the intersection data. The method further includes receiving (via the at least one computer device) user input data regarding at least one local condition for the existing facility and the at least one proposed facility, determining (via the at least one computing device) a predicted crash frequency for the existing facility based at least on a set of Safety Performance Functions (SPFs) associated with a facility type for the existing facility, determining (via the at least one computing device) a predicted crash frequency for the at least one proposed facility based at least on a set of Safety Performance Functions (SPFs) associated with a facility type of the at least one proposed facility, determining (via the at least one computing device) a conversion factor for each of the at least one proposed facility based on the predicted crash frequency of the existing facility and the predicted crash frequency of the at least one proposed facility, determining (via the at least one computing device) a crash severity distribution by crash types, determining (via the at least one computing device) an impact of local traffic volume for the at least one proposed facility, and generating a user interface via the at least one computing device. The user interface can be configured to render a graphical representation of at least each conversion factor for the at least one proposed facility.

In accordance with another embodiment, a system for generating a predictive safety assessment of at least one existing facility and at least one proposed facility includes at least one processor, and a non-transitory computer-readable medium in communication with the at least one processor. The at least one processor can be configured to execute instructions embodied on the computer-readable medium to perform operations including obtaining segment data and intersection data about an existing facility, obtaining segment data and intersection data about at least one proposed facility, rendering a first user interface configured to obtain user input about at least one local condition for the existing facility and the at least one proposed facility, determining a predicted crash frequency for the existing facility based at least on a set of Safety Performance Functions (SPFs) associated with a facility type for the existing facility, determining a predicted crash frequency for the at last one proposed facility based at least on a safety performance function (SPF) associated with a facility type for the at least one proposed facility, determining a conversion factor for each of the at least one proposed facility based on the predicted crash frequency of the existing facility and the predicted crash frequency of the at least one proposed facility, determining a crash severity distribution by crash types, determining an impact of local traffic volume for the at least one proposed facility, and rendering a second user interface configured to render a graphical representation of at least each conversion factor for the at least one proposed facility.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 provides one example illustration of a computing environment employed in a networked environment according to various embodiments of the present disclosure;

FIG. 2 illustrates a method for generating a predictive safety assessment of at least one existing facility and at least one proposed facility using a predictive safety assessment tool according to various embodiments of the present disclosure;

FIG. 3 illustrates an example user interface of a predictive safety assessment tool according to various embodiments of the present disclosure;

FIGS. 4A-4C illustrate example user interfaces of a predictive safety assessment tool, the user interfaces configured for receiving and displaying input including user input regarding at least one existing facility according to various embodiments of the present disclosure;

FIGS. 5A-5C illustrate example user interfaces of a predictive safety assessment tool, the user interfaces configured for receiving and displaying input including user input regarding at least one proposed facility according to various embodiments of the present disclosure;

FIG. 6 illustrates an example user interface of a predictive safety assessment tool, the user interface providing a dashboard for output information according to various embodiments of the present disclosure;

FIGS. 7A-7D illustrate example user interfaces of a predictive safety assessment tool, the use interfaces providing sensitivity analysis according to various embodiments of the present disclosure;

FIGS. 8A-8D illustrate example user interfaces of a predictive safety assessment tool, the user interfaces configured for receiving user input regarding at least one proposed facility according to various embodiments of the present disclosure;

FIG. 9 illustrates an example user interface of a predictive safety assessment tool, the user interface providing a dashboard for output information according to various embodiments of the present disclosure; and

FIGS. 10A-10C illustrate example user interfaces of a predictive safety assessment tool, the use interfaces providing sensitivity analysis according to various embodiments of the present disclosure.

### DETAILED DESCRIPTION

In the following paragraphs, the embodiments are described in further detail by way of example with reference to the attached drawings. In the description, well known components, methods, and/or processing techniques are omitted or briefly described so as not to obscure the embodiments. As used herein, the “present disclosure” refers to any one of the embodiments described herein and any equivalents. Furthermore, reference to various feature(s) of the “present embodiment” is not to suggest that all embodiments must include the referenced feature(s).

Among embodiments, some aspects of the present disclosure are implemented by a computer program executed by one or more processors, as described and illustrated. As would be apparent to one having ordinary skill in the art, one or more embodiments may be implemented, at least in part, by computer-readable instructions in various forms, and the present disclosure is not intended to be limiting to a particular set or sequence of instructions executed by the processor.

The embodiments described herein are not limited in application to the details set forth in the following description or illustrated in the drawings. The disclosed subject matter is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein, the terms “machine,” “computer,” and “server” are not limited to a device with a single processor, but may encompass multiple devices (e.g., computers) linked in a system, devices with multiple processors, special purpose devices, devices with various peripherals and input and output devices, software acting as a computer or server, and combinations of the above.

The impact of predictive safety assessment based on quantitative methodology of the Highway Safety Manual (HSM) is significant particularly in urban roadway facilities. The responsibilities of safety professionals, transportation planners, and decision makers are critical for safe and efficient transportation in the ever-increasing travel demand in urban areas. The present disclosure describes systems and methods for predictive safety assessment that may be used for quantitative safety assessment. In various aspects, the systems and methods can include a predictive safety assessment tool (also referenced herein as a “PSAT”) executable by at least one computing device to determine the quantitative safety measures of converting one facility type to another in terms of crash increase or decrease. The predictive safety assessment tool can include road widening projects in urban and rural areas, intersection improvement projects, and other safety improvement projects. The predictive safety assessment tool can consider the local existing roadway conditions, and local calibration factors specific to a local facility to determine a predicted crash frequency. The predicted crash frequency in each of the projects can be based, for example, on Safety Performance Functions (SPFs) for a facility, one or more corresponding Crash Modification Factors (CMFs) and local Calibration Factors (Cs). In some embodiments, the predictive safety assessment tool is a Microsoft® Excel® workbook embedded with functionality that can provide a simplified framework of converting one facility to another taking into consideration improvements to specific geometric elements in urban and suburban settings. The predictive safety assessment tool can be used to input and select traffic, and to define existing geometric conditions. In some embodiment, the predictive safety assessment tool can, for example, obtain data (e.g., from a database), including segment data and intersection data, about one or more facility types associated with existing facilities (e.g., roadway facility or intersection facility) and proposed facilities (e.g., a roadway facility or intersection facility). In some embodiments, the predictive safety assessment tool may receive data regarding local conditions and geometric elements for an existing facility from a user (e.g., via a user interface) or from a memory and may receive local conditions and geometric elements for a proposed facility from a user (e.g., via a user interface). Examples of a roadway facility include, but are not limited to, 2-lane undivided (2U), 2-lane undivided with left-turn lane (TWLTL). 4-lane undivided (4U), 4-lane divided (4D), 2-lane undivided with TWLTL, 4-lane undivided with TWLTL, 6-lane undivided (6D), and 8-lane divided facilities (8D). Examples of intersection facilities include, but are not limited to, unsignalized three-leg (3ST), unsignalized four-leg (4ST), signalized three-leg (3SG), and signalized four-leg (4SG).

The predictive safety assessment tool can also determine a predicted crash frequency for an existing facility and one or more of the proposed facilities based on applying Safety Performance Functions (SPF's), Crash Modification Factors (CMFs), and/or a local calibration factor (for a facility type). In some embodiments, the predictive safety assessment too can provide predicted crash frequency and distribution of collision types by severity for existing and proposed facilities.

In some embodiments the predictive safety assessment tool may be used to determine a conversion factor for each of the proposed facilities. The ratio of predicted crash frequency between a proposed and an existing facility indicates a notion of safety assessment in converting one facility into another, which suggests quasi Crash Modification Factor (CMF). In some embodiments, the conversion factor may be used to indicate an increase or decrease of predicted crash frequency for a proposed facility relative to the existing facility. The predictive safety assessment tool can be used to determine a crash severity distribution by crash types, and/or determine an impact of traffic (e.g., traffic volume such as AADT) for each of the plurality of proposed facilities, among other things.

In many aspects of the disclosure, the predictive safety assessment tool can determine the safety performance of existing facilities and compare to improved conditions of proposed facilities, including by applying the Highway Safety Manual (HSM) predictive methodology and principles, among other things. In some embodiments, the predictive safety assessment tool can include configuration and customization features to help the user (e.g., safety analysts) to input values in color-coded areas with recommended ranges from the HSM. Advantageously, in some embodiments the predictive safety assessment tool can 1) analyze the conversion of existing facility to proposed facility with improvement in urban/suburban arterial systems considering geometric, operations and traffic parameters.; 2) provide a user-friendly dashboard of safety performance of existing and proposed (improved) facilities in urban//suburban arterial systems and provide crash frequency by severity and crash types; and 3) provide sensitivity analysis for impact of traffic (e.g., AADT) on safety performance of existing and proposed (improved) facilities in urban/suburban arterial systems with more flexibility of user input considering the local conditions.

The predictive safety assessment tool can advantageously enable safety researchers, engineers, and transportation planners at the agency level to understand and quantify the impact of safety improvements. The predictive safety assessment tool can help safety professionals, transportation planners, and decision-makers to evaluate safety effects considering the local conditions to make informed decisions in the planning process from the traffic safety standpoint. In some embodiments, the predictive safety assessment tool can be used to evaluate the safety impacts of converting one type of existing facility to another type of facility (for example, converting a 2-lane undivided to 4-lane divided, converting a 4-lane undivided to 4-lane divided, converting a 3-lane undivided to 5-lane undivided, converting a 6-lane divided to 8-lane divided facilities, etc.) as well as to evaluate the impacts of improvements to specific geometric elements in urban settings. Input for the predictive safety assessment tool can include, for example, data regarding road geometry features, traffic (Annual Average Daily Traffic, (AADT), and other existing land use information. In some embodiments, the predictive safety assessment tool can provide a simplified framework for converting one type of facility to another by inputting and selecting, for example, traffic exposure, existing geometric conditions, and unit length of corridor (i.e., one mile of corridor length). The predictive safety assessment tool can assist in evaluating existing and proposed facilities from the outcome of analysis in the form of predicted crash frequency and distribution of collision types by injury severity level. In addition, in some embodiments, the predictive safety assessment too can be used to provide a notion of impact of traffic volume on predicted crashes by crash types. In some embodiments, from the perspective of roadway widening and considering safety in a decision-making matrix, the predictive safety assessment tool can provide an insight why and how policy makers and safety professionals can make an informed decision at, for example, the planning phase of the roadway construction projects.

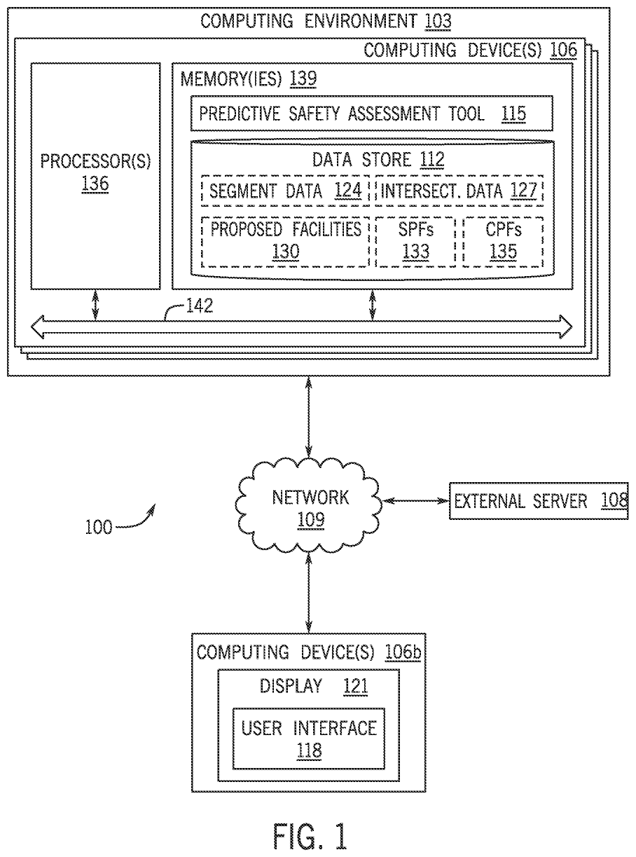

Turning to the drawings, FIG. 1 shows a networked environment 100 according to various embodiments. The networked environment 100 includes a computing environment 103, one or more computing devices 106, and an external server 108 in data communications via a network 109. The computing devices(s) 106 may comprise, for example, a server computer, a client computing device, or any other system providing computing capability. The network 109 includes, for example, the internet, intranets, extranets, wide area networks (WANs), local area networks (LANs), wired networks, wireless networks, cable networks, satellite networks, or other suitable networks, etc., or any other combination of two or more such networks. The external server 108 may be any computing device, computing environment, data provider, or service provider, which may be provided by a third-party or by the provided or computing environment 103.

Various applications and/or other functionality may be executed in the computing environment 103 according to various embodiments. Also, various data may be stored in a data store 112 that is accessible to the computing environment 103. The data store 112 may be representative of a plurality of data stores 112 as can be appreciated. The data stored in the data store 112, for example, is associated with the operation of the various applications and/or functional entities described below. The components executed on the computing environment 103, for example, include a predictive safety assessment tool 115, and other applications, services, processes, systems, engines, or functionality not discussed in detail herein.

The predictive safety assessment tool 115 may be executed to enable safety researchers, engineers, and transportation planners at the agency level to understand and quantify the impact of safety improvements, and to provide a simplified framework to evaluate the safety impacts of converting one type of facility to another (e.g., 2-lane undivided to 2-lane undivided with left-turn lane (TWLTL), 4-lane undivided to 4-lane divided, 2-lane undivided with TWLTL to 4-lane undivided with TWLTL, or 6-lane divided to 8-lane divided facilities). The predictive safety assessment tool 115 can provide an understanding of the impact of a set of improvement projects relative to the existing condition at a quantitative scale, which is sometime referred to a “sensitivity analysis.” In some examples, the predictive safety assessment tool 115 can extend concepts from the Highway Safety Manual (HSM) provided by the American Association of State Highway and Transportation Officials (AASHTO) or other concepts useful to quantify crash increase or decrease from facility conversions. The sensitivity analysis can, for example, focus on the impact of traffic volume on predicted crash frequency for different types of crashes.

Although not explicitly depicted in the example of FIG. 1, it is contemplated that the systems and method disclosed herein can be executed by one computing device 106, such as an analyst workstation, or any other system providing computing capability. According to an embodiment, one or more of the computing devices 106 (e.g., the computer device 106 and/or the computing device 106b) may be configured to execute various applications such as a client application to access network content served up by the predictive safety assessment tool 115, thereby rendering a user interface 118 on a display 121. In some embodiments, the predictive safety assessment tool 115 can be provided as a Microsoft® Excel® workbook embedded with functionality that can be implemented in Visual Basic®.

The display 121 may comprise, for example, one or more devices such as liquid crystal display (LCD) displays, gas plasma-based flat panel displays, organic light emitting diode (OLED) displays, electrophoretic ink (E ink) displays, LCD projectors, or other type of display devices, etc. In another example, it is contemplated that one of the computing devices 106 can execute the predictive safety assessment tool 115, and render user interface 118 on the display 121 of the computing device 106b.

The client application may comprise, for example, a browser, a dedicated application, etc., and the user interface 118 may comprise a network page, an application screen, etc. The computing device 106 may be configured to execute applications beyond the client application such as, for example, email applications, word processors, spreadsheets, traffic safety applications, and/or other applications.

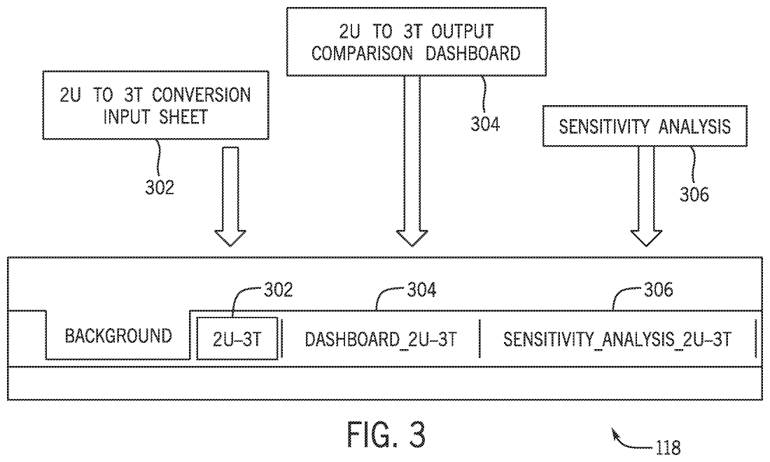

The predictive safety assessment tool 115 may be configured to generate a user interface 118, such as any of those shown in FIGS. 3-10B. The predictive safety assessment tool 115 can, for example, generate a user interface 118 which is configured to render a dashboard for one of the proposed facilities.

The predictive safety assessment tool 115 can consider, for example, the local existing roadway conditions and local calibration factors specific to a local facility to determine a predicted crash frequency. In one example, the dashboard can be configured to include a predicted annual average crash frequency. In another example, the dashboard can be configured to render at least an indication of a predicted crash frequency, a predicted annual crash frequency, an annual average daily traffic (AADT), a total number of crashes, a number of Property Damage Only (PDO) crashes, or a number of fatal-injury crashes for the proposed facilities.

The data stored in the data store 112 can include, for example, segment data 124, intersection data 127, proposed facilities 130, Safety Performance Functions (SPFs) 133, Crash Modification Factors (CMFs) 135, and potentially other data. The segment data 124 can include, for example, data about facility type (2U, 3T, 4U, 4D, 5T, etc.), length, traffic (e.g., average daily traffic or annual average daily traffic), on-street parking, average median width, street lighting, speed limit, driveways, distance of fixed objects, density of fixed roadside objects, or other data about one or more segments of roadway.

The intersection data 127 can include, for example, data about facility type (3SG, 4SG, 3ST, 4ST, etc.) traffic (e.g., average daily traffic), number of approaches with left-turn lanes, number of approaches with right-turn lanes, number of approaches with left-turn-signal phasing, left-turn phasing type, maximum number of lanes crossed by a pedestrian, number of bus stops/schools/liquor stores within a predefined number of feet of the intersection center, or other data about one or more intersections of roadways.

The proposed facilities 130 can include data about a proposed facility associated with a road widening, intersection improvement, or other roadway project. In one example of a roadway project that involves road widening of a facility type that is a section of roadway, a 2-lane undivided (2U) section of the roadway can be widened to create a 2-lane undivided with two-way left-turn lane (TWLTL) or (3T) section. The proposed facilities 130 can include data about the proposed facility (e.g., 3T), the improved condition of the roadway section, and potentially other data related to one or more proposed facilities. In an example of a roadway project that involves an intersection improvement of a facility type that is a 4-leg signalized intersection, an intersection having no left-turn lane (or no right-turn lane) can be improved to provide left-turn lane (or right-ten lane) etc. The proposed facilities 130 can include data about the proposed facility (e.g., left-turn lane), or the improved condition of the intersection.

The SPFs 133 can include data about SPFs, including SPFs that are specific to facilities, e.g., segments defined within the segment data 124 or intersections defined with the intersection data 127. An SPF is a crash prediction model for predicting the number of crashes or crash frequency. An SPF is typically developed for a particular type of facility using observed crash data from a number of similar sites. An SPF for a facility type can be based on AADT as well as other facility characteristics (e.g., lane width, shoulder width, radius/degree of horizontal curves, presence of turn lanes (at intersections, and traffic control (at intersections). In some embodiments, the SPFs 133 may include general SPFs for each facility type, for example, obtained from the HSM. In some embodiments, the SPFs may include SPFs for a facility type that have been developed for a specific jurisdiction (e.g., a state or region), namely, a jurisdiction specific SPF. The SPFs. 133 may be stored in memory 139 or may be retrieved or obtained from the external server 108. The CMFs 135 can include data about crash modification factors for the proposed facilities 130 and/or facilities defined within the segment data 124 or the intersection data 127. CMFs can be used to adjust a predicted crash frequency of an SPF for local conditions for a facility that may be different from the base conditions of an SPF for a facility type. One or more CMFs may correspond to a particular SPF. Each CMF may be associated with a countermeasure and can indicate how much the given countermeasure can reduce the number of crashes. In some embodiments, the CMFs 135 may be known and can be stored in memory 139 or may be retrieved or obtained from the external server 108, for example, from a database (or clearinghouse) of CMFs. The CMFs associated and used with a particular SPF may be defined in the HSM.

According to an embodiment of the present disclosure, each computing device 106 includes at least one processor circuit, for example, having a processor 136 and a memory 139, both of which are coupled to a local interface 142. To this end, each computing device 106 may comprise, for example, at least one server computer, personal computer, workstation, or like device. The local interface 142 may comprise, for example, a data bus with an accompanying address control bus or other bus structure as can be appreciated.

Stored in the memory 139 are both data and several components that are executable by the processor 136. In particular, stored in the memory 139 and executable by the processor 136 are the predictive safety assessment tool 115, and potentially other applications. Also stored in the memory 139 may be the data store 112 and other data. In addition, an operating system may be stored in the memory 139 and executable by the processor 136.

It is understood that there may be other applications that are stored in the memory 139 and are executable by the processor 136 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby Flash®, or other programming languages.

A number of software components are stored in the memory 139 and are executable by the processor 136. In this respect, the term “executable” means a programmable file that is in a form that can ultimately be run by the processor 136. Examples of executable programs may be, for example, a compiled program that can be translated into machine code in a format that can be loaded into a random access portion of the memory 139 and run by the processor 136, source code that may be expressed in proper format such as object code that is capable of being loaded into a random access portion of the memory 139 and executed by the processor 136, or source code that may be interpreted by another executable program to generate instructions in a random access portion of the memory 139 to be executed by the processor 136, etc. An executable program may be stored in any portion or component of the memory 139 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 139 is defined herein as including both volatile and nonvolatile memory and data storage components. Volatile components are those that do not retain data values upon loss of power. Nonvolatile components are those that retain data upon a loss of power. Thus, the memory 139 may comprise, for example, random access memory (RAM), read-only memory (ROM), hard disk drives, solid-state drives, USB flash drives, memory cards accessed via memory card reader, floppy disks accessed via an associated floppy disk drive, optical discs accessible via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 136 may represent multiple processors 136 and/or multiple processor cores and the memory 139 may represent multiple memories 139 that operate in parallel processing circuits, respectively. In such a case, the local interface 142 may be an appropriate network that facilitates communication between any two of the multiple processors 136, between any processor 136 and any of the memories 139, or between any two of the memories 139, etc. The local interface 142 may comprise additional systems designed to coordinate this communication, including, for example, performance load balancing. The processor 136 may be of electrical or of some other available construction.

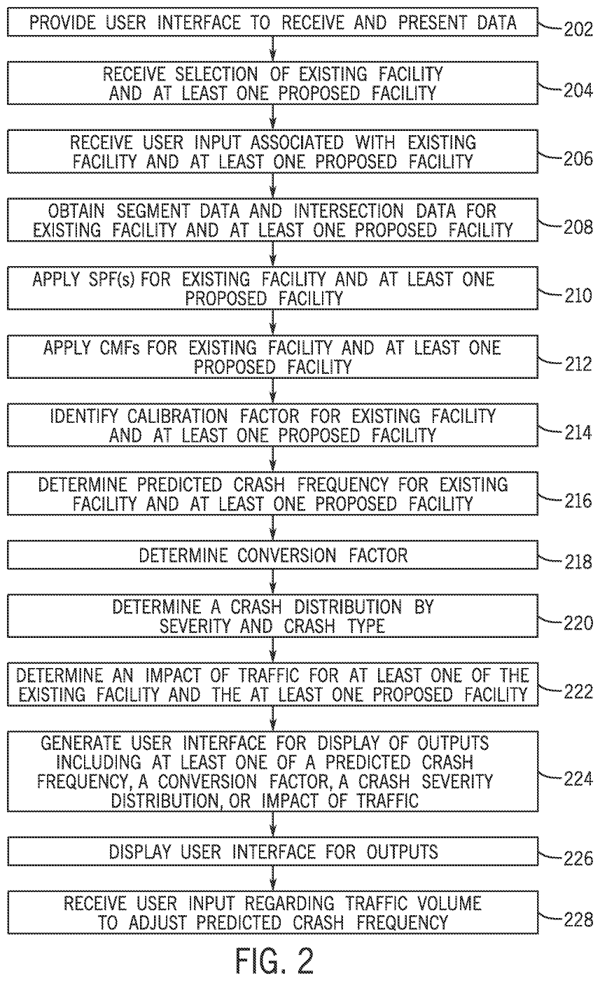

FIG. 2 illustrates a method for generating a predictive safety assessment of at least one existing facility and at least one proposed facility using a predictive safety assessment tool according to various embodiments of the present disclosure. FIG. 2 provides an example of the operations of portions of the predictive safety assessment tool 115 (FIG. 1) according to various embodiments of the present disclosure. It is understood that FIG. 2 provides an example of the many different types of functional arrangements that may be employed to implement the operation of portions of the predictive safety assessment tool 115 as described herein. In some embodiments, the elements of the method of FIG. 2 may be implemented in the networked environment 100 (FIG. 1) according to one or more embodiments.

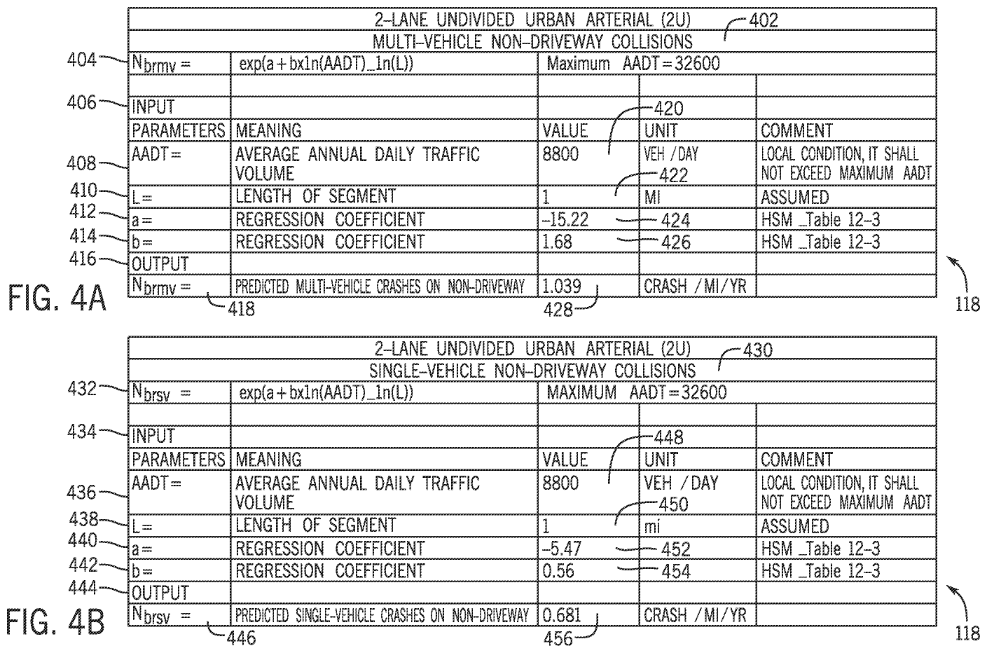

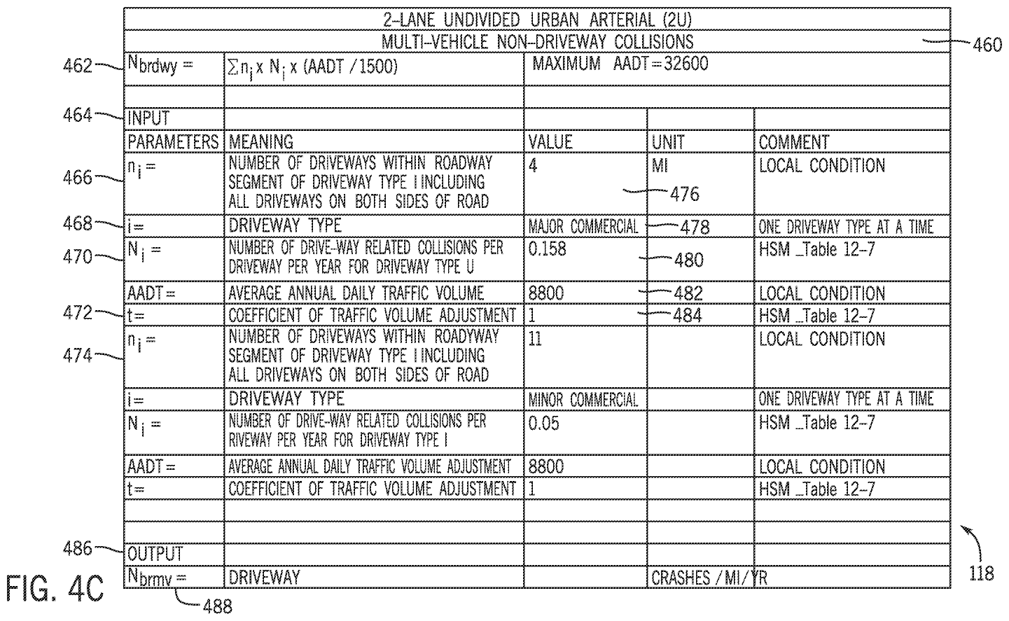

At block 202, the predictive safety assessment tool 115 can provide or render a user interface 118 to receive and present data (e.g., user interfaces 118 shown in FIGS. 4A-4C, 5A-5C and FIGS. 8A-8D). At block 204, a user may select an existing facility and at least one proposed facility for analysis or evaluation using the user interface 118 (e.g., by entering a selection, or choosing a box, choosing a tab on a workbook, or selecting from a drop-down menu). For example, the selected existing facility may be a 2-lane undivided (2U) roadway and the at least one proposed facility may be a 2-lane undivided roadway with TWLTL (3T). At block 206, user input for the existing facility and the at least one proposed facility may be received using the user interface 118. As mentioned above, the received data may be, for example, local conditions including, but not limited to, AADT. In some embodiments, the user input data may be received, for example, by entering a selection in a cell (e.g., of a workbook), choosing a box, choosing a tab (e.g., on a workbook), selecting a button, or selecting from a drop-down menu. At block 208, the predictive assessment tool 115 may obtain segment data 124 and intersections data 126 associated with the existing facility and the proposed facility. In some embodiments, the obtained segment data 124 and intersection data 127 for the existing facility and the at least one proposed facility may be displayed in the user interface.

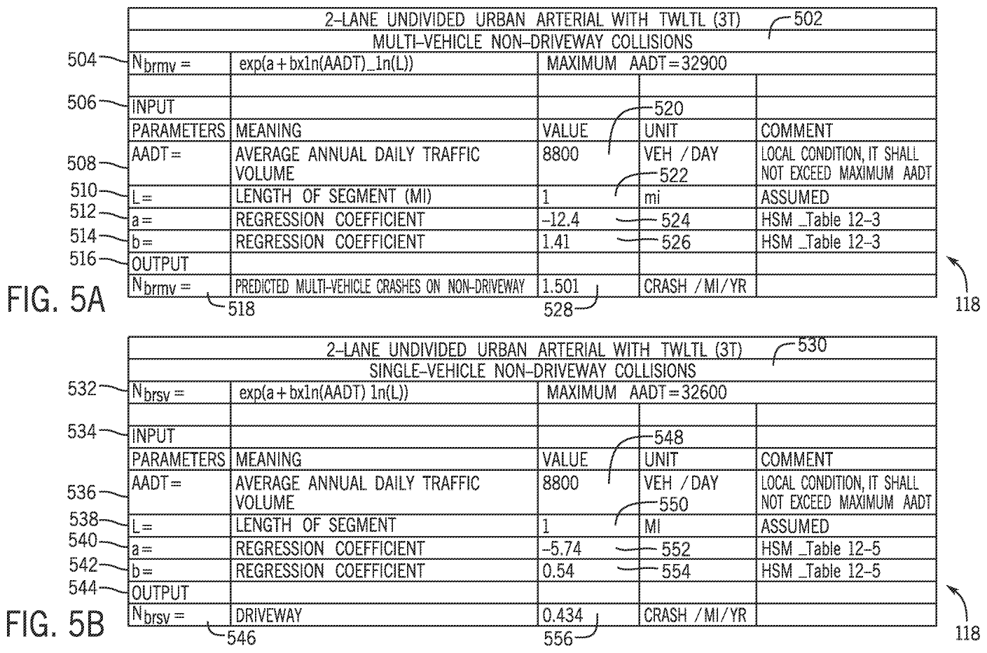

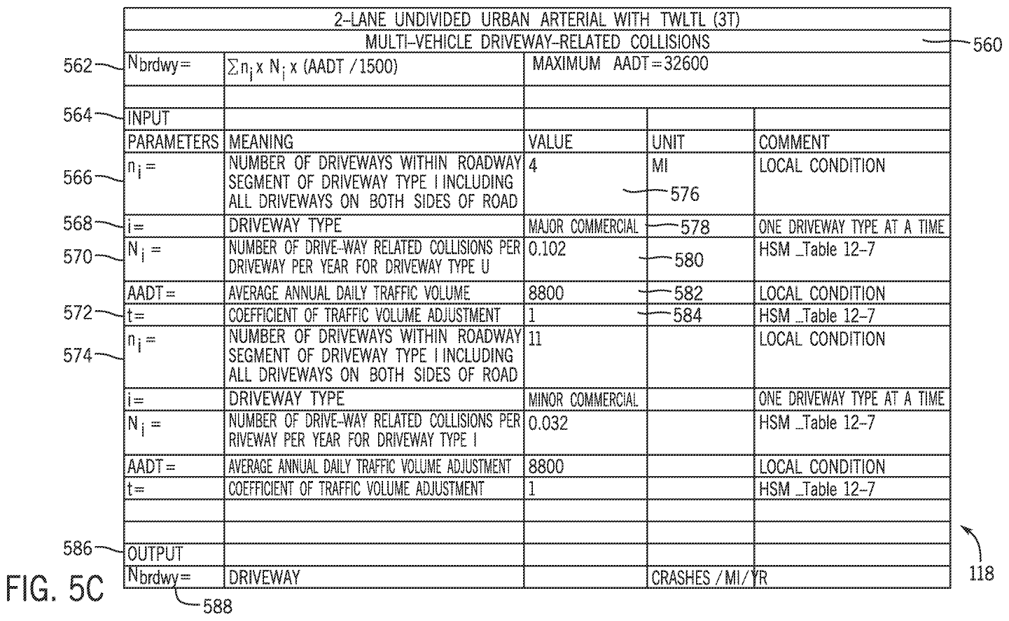

At block 210, the predictive safety assessment tool 115 applies an SPF (e.g., retrieved from SPFs 133) for the facility type of the existing facility using the appropriate data for the SPF from the data associated with the existing facility (e.g., the user input data, the segment data, the intersection data, etc.) to determine a base crash frequency prediction for the existing facility and the predictive safety assessment tool 115 applies an SPF (e.g., retrieved from SPFs 133) for the facility type of the proposed facility using the appropriate data for the SPF from the data associated with the proposed facility (e.g., the user input data, the segment data, the intersection data, etc.) to determine a base crash frequency prediction for the proposed facility. In some embodiments, s set of SFS are applied to the existing facility and a set of SPFS are applied to the proposed facility. For example, a set of SPFs for the existing facility may include SPFs applied for different crash types for the facility type (e.g., multi-vehicle non-driving collision, single-vehicle non-driveway collision, etc. (e.g., as shown in FIGS. 4A-4C)) and a set of SPFs for the proposed facility may include SPFs applied for different crash types for the facility type (e.g., multi-vehicle non-driving collision, single-vehicle non-driveway collision, etc. (e.g., as shown in FIGS. 5A-5C)). In some embodiments where a set of SPFs is applied, the set of SFs can be combined (e.g., multiplied) to determine an SPF for the existing or proposed facility type. In some embodiments, if more than one proposed facility is being compared to the existing facility, an SPF or set of SPFs is applied for each proposed facility determine a base crash frequency prediction for the proposed facility. As discussed above, in some embodiments, it can be beneficial for the predicative safety assessment tool 115 to obtain information about processes (e.g., SPFs) for HSM predictive methods from the external server 108. As mentioned, in some embodiments, an SPF or set of SPFs (e.g., from SPFs 133) can be applied to an existing or proposed facility type for various types of collisions, e.g., multi-vehicle, single-vehicle, vehicle-pedestrians, or vehicle-bicycle. In some embodiments, the base crash frequency predictions determined at block 210 may be stored in a memory (e.g., memory 13) and may be displayed on a user interface. In some embodiments, an actual number of crashes or crash frequency for an existing facility may be retrieved, for example, from memory 139 or external server 108. In some embodiments, the actual number of crashes or crash frequency for an existing facility may be displayed on a user interface.

At block 212, the predictive safety assessment tool 115 can apply the CMFs associated with an SPF applied to the existing facility. For example, in some embodiments the CMFs (n) corresponding to the SPF (or set of SPFs) for the existing facility may be combined as (CMF₁×CMF₂× . . . ×CMFₙ). The values for the CMFs corresponding to the SPF (or set of SPFs) for the existing facility or the combination of the CMFs may be stored in, for example a memory (e.g., memory 139). In addition, the predictive safety assessment tool 115 can apply the CMFs associated with an SPF (or set of SPFs) applied to the proposed facility. For example, in some embodiments the CMFs (n) corresponding to the SPF (or set of SPFs) for the proposed facility may be combined as (CMF₁×CMF₂× . . . ×CMFₙ). As mentioned above, the CMFs corresponding to an SPF (or set of SPFs) can be used to adjust the base predicted crash frequency for local conditions for a facility (existing or proposed) that may be different from the base conditions of an SPF (or set of SPFs) for a facility type. The values for the CMFs corresponding to the SPF (or set of SPFs) for the proposed facility or the combination of the CMFs may be stored in, for example a memory (e.g., memory 139). In some embodiments, if more than one proposed facility is being compared to the existing facility, CMFs for each SPF applied for each proposed facility may be identified and applied. At block 214, the predictive safety assessment tool 115 identifies and retrieves a calibration factors (C) for the existing facility and one or more proposed facilities, if necessary. A calibration factor is used to adjust the base predicted crash frequency from an SPF for accuracy in the jurisdiction (e.g., a state or local area). In some embodiments, a calibration factor may not be necessary if, for example, the applied SPF is a jurisdiction specific SPF. In some embodiments, the one or more calibration factors may be obtained from the external server 108.

At block 216, the predictive safety assessment tool 115 determines a predicted crash frequency for each exiting facility and proposed facility based on at least the SPF or set of SPFs (block 210), the corresponding CMFs (block 212), and any necessary calibration factors (block 214). In one example, a basic formulation for predicted crash frequency by facility is provided as follows:

Safety Prediction Model (N_{predicted})=SPF×(CMF₁, CMF₂, . . . CMFₙ)×C Eq. 1

where the safety prediction model is the annual average predicted crash frequency, SPF is the safety performance function or set of safety performance functions, CMF₁, CMF₂, . . . CMFₙ are crash modification factors, and C is a calibration factor. In some embodiments, the predicted crash frequency determined for an existing facility and one or more proposed facilities at block 216 may be stored in a memory (e.g., memory 139) and may be displayed on a user interface as discussed further below.

At block 218, the predictive safety assessment tool 115 can generate a conversion factor based at least in part on a predicted crash frequency. In some embodiments, the conversion factor can be determined by:

$$\frac{Predicted Crashes ( Crash Frequency ) of Proposed Facility}{Predicted Crashes ( Crash Frequency ) of Existing Facility} \qquad Eq . 2$$

The conversion factor may be used to indicate an increase or decrease of predicted crash frequency for a particular proposed facility relative to the existing facility. For example, a conversion factor less than 1 (<1) can indicate a decrease in crashes (or crash frequency) for a proposed facility relative to an existing facility and a conversion factor greater than 1 (>1) can indicate an increase in crashes (or crash frequency) for a proposed facility related to an existing facility. In some embodiments, a conversion factor that equals 1 can indicate that there is no change in the number of crashes (or crash frequency) for the proposed facility relative to the existing facility, i.e., the crash frequency is the same. In some embodiments, the conversion factor determined for one or more proposed facilities at block 218 may be stored in a memory (e.g., memory 139) and may be displayed on a user interface as discussed further below.

At block 220, the predictive safety assessment tool 115 can determine a distribution of crashes by severity and crash types. For example, a distribution of crash severity types (e.g., fatal-injury, property damage only (PDO)) for each type of crash (e.g., multi-vehicle, single-vehicle, etc.) may be determined. In some embodiments, the crash types can include, for example multi-vehicle collision (MV), rear-end crash (RE), head-on collision (HO), angle collision (ANG), sideswipe in same direction collision (SSD), Sideswipe in opposition direction collision (SOD), single-vehicle collision (SV), animal collision (ANM), fixed object collision (FO), other object collision (OTH-OBJ), pedestrian collision (PED), and pedal-cycle collision (PDC). Advantageously, the predictive assessment tool 115 can consider vehicle-pedestrian and vehicle-pedal-cycle collisions apart from vehicle only crashes which can add value by considering the speed limit of the corridor. In another example, a crash distribution by only crash type or only severity type can be determined. In some embodiments, the distribution of crashes by severity and crash types determined at block 220 may be stored in a memory (e.g., memory 139) and may be displayed on a user interface as discussed further below. At block 222, the predictive safety assessment tool 115 can determine an impact of traffic (e.g., traffic volume) on crash frequency. In some embodiments, the impact of traffic (e.g., traffic volume) on crash frequency determined at block 222 may be stored in a memory (e.g., memory 139) and may be displayed on a user interface as discussed further below.

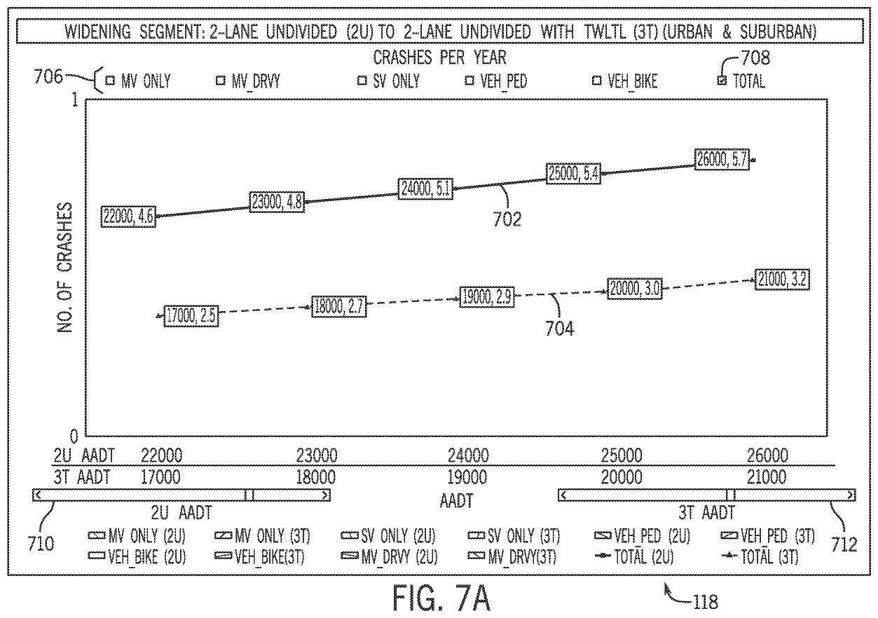

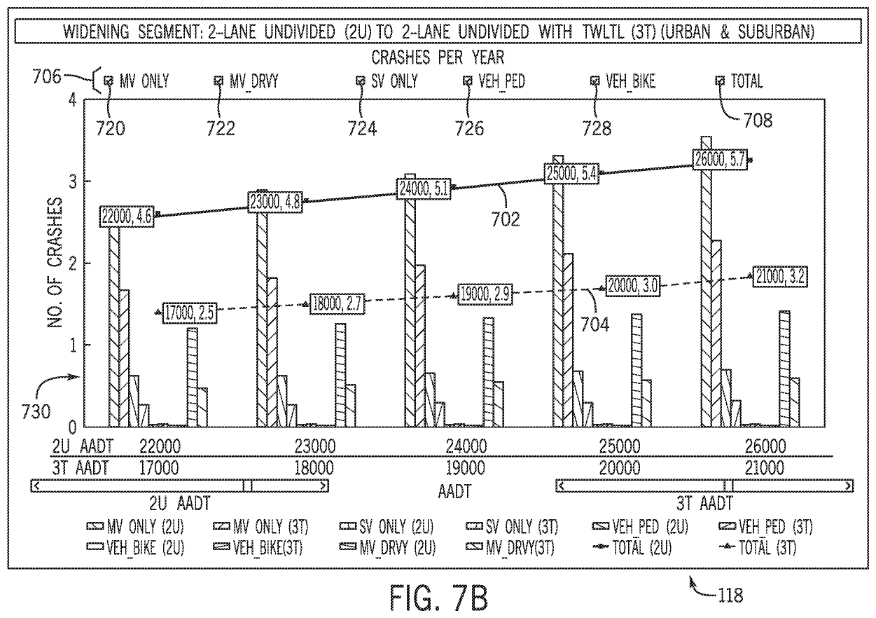

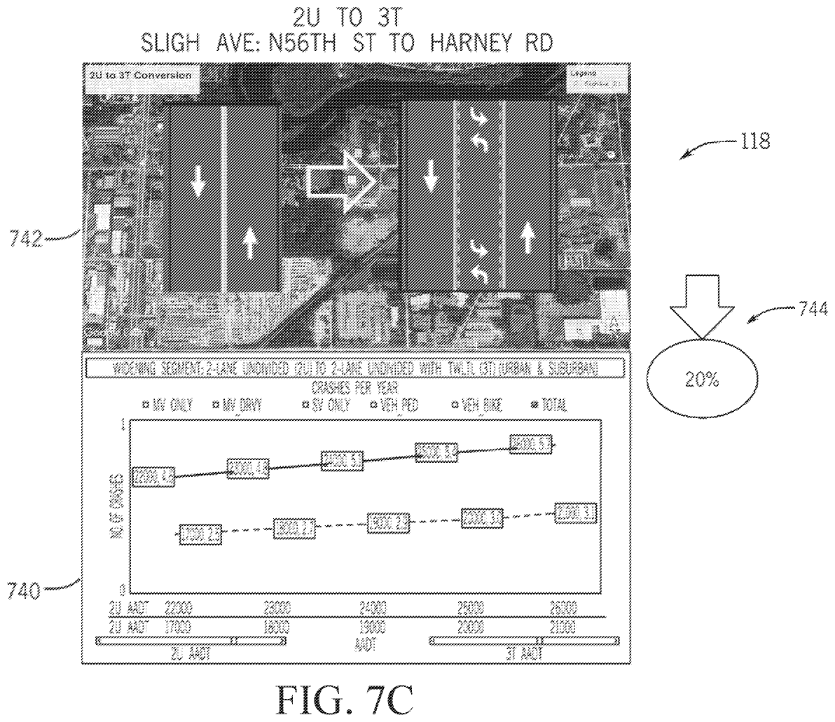

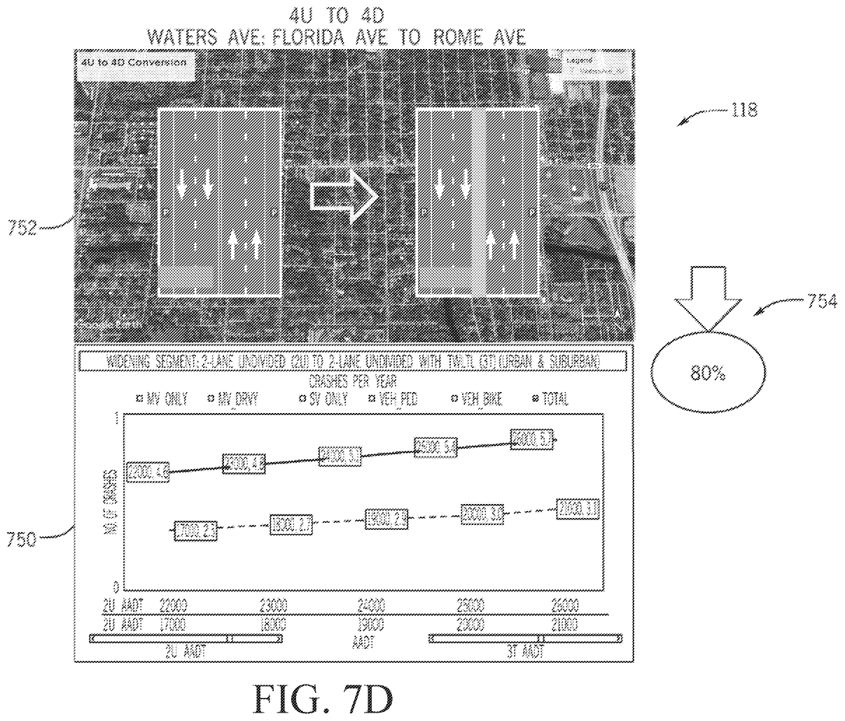

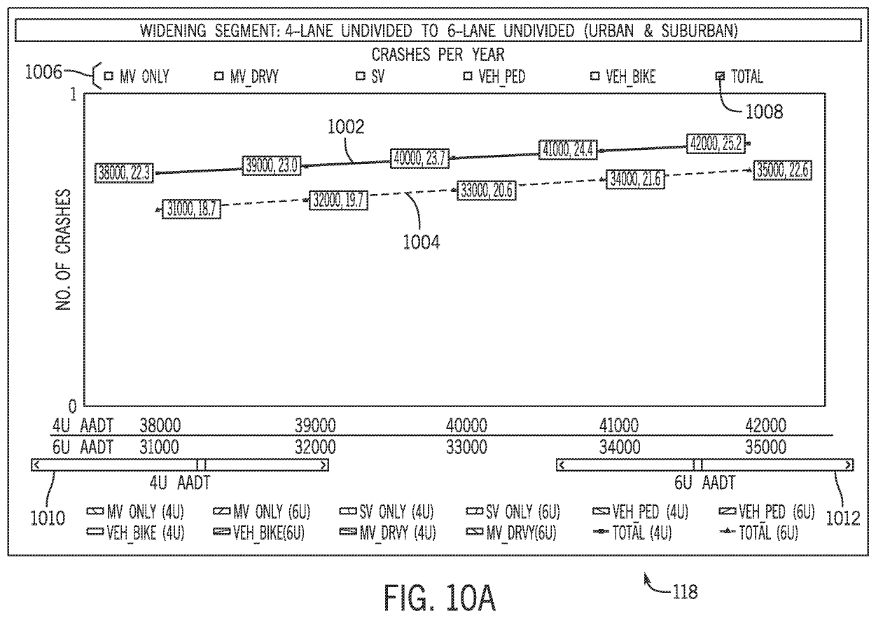

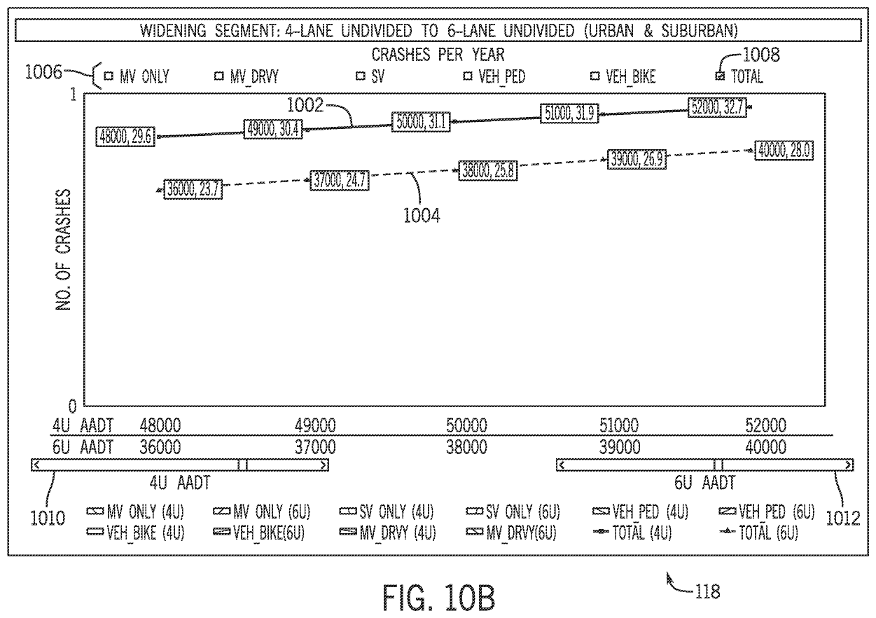

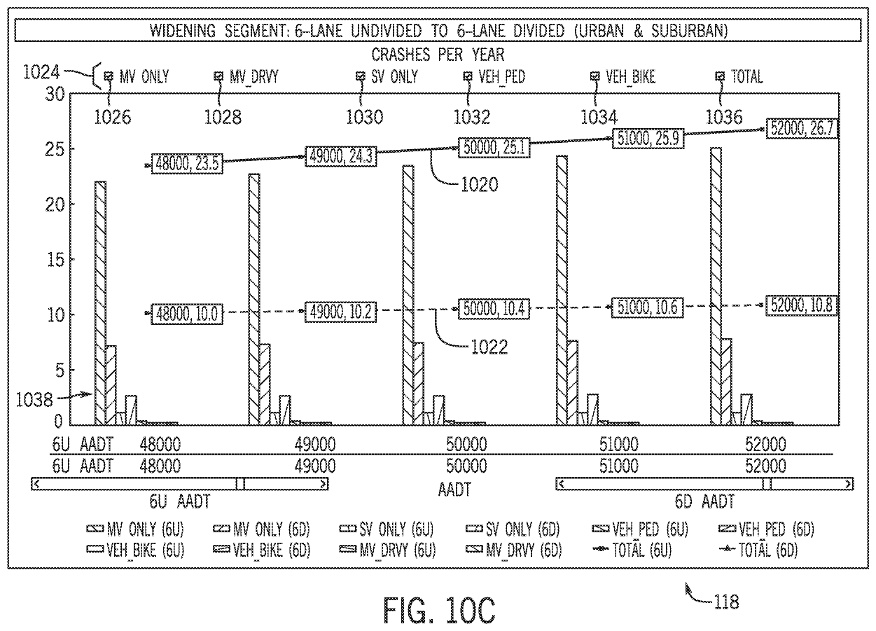

At block 224, the predictive safety assessment tool 115 can generate a user interface for display of outputs including, for example, at least one of a predicted crash frequency (e.g., for an existing facility or a proposed facility), a conversion factor for one or more proposed facilities, a crash severity distribution, or an impact of traffic. For example, the predictive safety assessment tool 115 can generate a user interface 118 comprising a distribution of crashes by types and severity based at least in part on the crash severity distribution by crash types for at least one of the proposed facilities 130. At block 226, the generated user interface for outputs may be displayed, for example, on display 121. At block 228, user input regarding traffic may be received by the predictive safety assessment tool 115 via the user interface generated at block 226 and used to adjust a predicted crash frequency for one or more proposed facilities. For example, as discussed further below with respect to FIGS. 7A, 7B, 10A and 10B, a user interface element, such as a slide input, may be used by a user to adjust the value of AADT for an existing or proposed facility. In such embodiments, the predicted crash frequency for the existing or proposed facility is adjusted and the user interface display or visualization (e.g., a graph) is also adjusted in response to the change in AADT.

As mentioned above, the predictive safety assessment tool 115 can generate or render a user interface 118 (FIG. 1) comprising graphical output or other output and/or text boxes or other elements for user input. FIGS. 3-10B illustrate example user interfaces for inputs and outputs for a predictive assessment tool 115/FIG. 3 shows an example of the predictive safety assessment tool 115 generating a user interface 118 having an input sheet 302, a comparison dashboard 304, and a sensitivity analysis 306 for an existing facility and at least one of the proposed facilities 130 according to various embodiments of the present disclosure. The comparison dashboard 304 can include a comparison of a number of crashes for one of the proposed facilities 130 and at least one of the existing facilities.

FIGS. 4A-4C illustrate example user interfaces of a predictive safety assessment tool, the user interfaces configured for receiving and displaying input including user input regarding at least one existing facility according to various embodiments of the present disclosure and FIGS. 5A-5C illustrate example user interfaces of a predictive safety assessment tool, the user interfaces configured for receiving and displaying input including user input regarding at least one proposed facility according to various embodiments of the present disclosure. In some embodiments, FIGS. 4A-4C and 5A-5C illustrate examples of a user interface 118 rendered in the networked environment of FIG. 1 according to various example embodiments of the present disclosure. Any of the user interfaces 118 shown in FIGS. 4A-4C and 5A-5C can, for example, be rendered on the display 121 of the computing device 106b (FIG. 1). In some embodiments, the example user interfaces 118 shown in FIGS. 4A-4C and 5A-5C may be combined and shown as a single user interface (e.g., a single worksheet) but are shown separately for simplicity and clarity.

FIGS. 4A-4C can be seen as examples of the predictive safety assessment tool 115 generating a portion of the user interface 118 that is an input sheet configured to obtain user input about an existing facility. The examples of FIGS. 4A-4C are directed to a conversion (e.g., a widening) of an 2-Lane Undivided (2U) facility to a 2-Lane Undivided Facility with TWLTL (3T). The examples user interfaces 118 in FIGS. 4A-4C are also directed to an analysis of a total number of crashes. In FIG. 4A, the user interface 118 includes a plurality of text boxes for input (e.g. received from a user) and for other data associated with the existing facility (2U) (e.g., received from a memory or external server). The data in the user interface of FIG. 4A is directed to a multi-vehicle non-driveway crash type 402. An SPF 404 (N_{brmv}) for the crash type is also shown. In this example, the input parameters 406 for the example SPF 404 include AADT 408, a length of a segment (L) 410, a first regression coefficient (a) 412, and a second regression coefficient (b) 414. The user interface may be configured to allow a user to input a value for a parameter, for example, text box 420 may be configured to allow a user to enter a value for AADT which is a local condition. Other parameters may be obtained from a memory or external server and the text boxes may be configured to not allow the value to be entered or changed. For example, text box 422 include the length of the segment 410 as an assumed value, and the text boxes 424 and 426 for the first 412 and second 414 regression coefficients include data from an appropriate table in the HSM (e.g., retrieved from an external server 108). The user interface 118 of FIG. 4A may also include an output 416, for example, a predicted crash frequency (N_{brmv}) 418, 428 from application of the SPF 404 to the 2U facility for multi-vehicle non-driveway collisions 402.

In FIG. 4B, the user interface 118 includes a plurality of text boxes for input (e.g., received from a user) and for other data associated with the existing facility (2U) (e.g., received from a memory or external server). The data in the user interface of FIG. 4B is directed to a single-vehicle non-driveway crash type 430. An SPF 432 (N_{brsv}) for the crash type is also shown. In this example, the input parameters 434 for the example SPF 432 include AADT 436, a length of a segment (L) 438, a first regression coefficient (a) 440, and a second regression coefficient (b) 442. The user interface may be configured to allow a user to input a value for a parameter, for example, text box 448 may be configured to allow a user to enter a value for AADT which is a local condition. Other parameters may be obtained from a memory or external server and the text boxes may be configured to not allow the value to be entered or changed. For example, text box 450 include the length of the segment 438 as an assumed value, and the text boxes 452 and 454 for the first 440 and second 442 regression coefficients include data from an appropriate table in the HSM (e.g., retrieved from an external server 108). The user interface 118 of FIG. 4B may also include an output 444, for example, a predicted crash frequency (N_{brmv}) 446, 456 from application of the SPF 432 to the 2U facility for multi-vehicle non-driveway collisions 420.

In FIG. 4C, the user interface 118 includes a plurality of text boxes for input (e.g., received from a user) and for other data associated with the existing facility (2U) (e.g., received from a memory or external server). The data in the user interface of FIG. 4C is directed to a multi-vehicle driveway-related crash type 460. An SPF 462 (N_{brdwy}) for the crash type is also shown. In this example, the input parameters 464 for the example SPF 462 include a number of driveways (nᵢ) within the roadway segment of driveway type i including all driveways on both sides of the road 466, a driveway type (i) 468, a number (Nᵢ) of driveway related collisions per driveway per year for driveway type i 470, AADT 472, and a coefficient (t) of traffic volume adjustment 474. As shown in FIG. 4C, data for each roadway type i (e.g., major commercial, minor commercial, major industrial/Institutional, major residential, etc.) may be included in the user interface for the facility type (2U). The user interface may be configured to allow a user to input a value for a parameter, for example, text box 476 may be configured to allow a user to enter a value for the number of driveways which is a local condition, box 478 may be configured as a drop down menu to allow a user to select a driveway type, and text box 482 may be configured to allow a user to enter a value for AADT which is a local condition. Other parameters may be obtained from a memory or external server and the text boxes may be configured to not allow the value to be entered or changed. For example, text box 480 and text box 484 include data from an appropriate table in the HSM (e.g., received from an external server 108). The user interface 118 of FIG. 4C may also include an output 486, for example, a predicted crash frequency (N_{brdwy}) 488 from application of the SPF 462 to the 2U facility for multi-vehicle driveway-related collisions 460.

FIGS. 5A-5C can be seen as examples of the predictive safety assessment tool 115 generating a portion of the user interface 118 that is an input sheet configured to obtain user input about at least one of a plurality of proposed facilities 130. The examples of FIGS. 5A-5C are directed to a conversion (e.g., a widening) of a 2-Lane Undivided (2U) facility to a 2-Lane Undivided Facility with TWLTL (3T). The examples user interfaces 118 in FIGS. 5A-5C are also directed to an analysis of a total number of crashes. In FIG. 5A, the user interface 118 includes a plurality of text boxes for input (e.g., received from a user) and for other data associated with the proposed facility (3T) (e.g., received from a memory or external server). The data in the user interface of FIG. 5A is directed to a multi-vehicle non-driveway crash type 502. An SPF 504 (N_{brmv}) for the crash type is also shown. In this example, the input parameters 506 for the example SPF 504 include AADT 508, a length of a segment (L) 510, a first regression coefficient (a) 512, and a second regression coefficient (b) 514. The user interface may be configured to allow a user to input a value for a parameter, for example, text box 520 may be configured to allow a user to enter a value for AADT which is a local condition. Other parameters may be obtained from a memory or external server and the text boxes may be configured to not allow the value to be entered or changed. For example, text box 522 include the length of the segment 510 as an assumed value, and the text boxes 524 and 526 for the first 512 and second 514 regression coefficients include data from an appropriate table in the HSM (e.g., retrieved from an external server 108). The user interface 118 of FIG. 5A may also include an output 516, for example, a predicted crash frequency (N_{brmv}) 518, 528 from application of the SPF 504 to the 3T facility for multi-vehicle non-driveway collisions 502.

In FIG. 5B, the user interface 118 includes a plurality of text boxes for input (e.g., received from a user) and for other data associated with the proposed facility (3T) (e.g., received from a memory or external server). The data in the user interface of FIG. 5B is directed to a single-vehicle non-driveway crash type 530. An SPF 532 (N_{brsv}) for the crash type is also shown. In this example, the input parameters 534 for the example SPF 532 include AADT 536, a length of a segment (L) 538, a first regression coefficient (a) 540, and a second regression coefficient (b) 542. The user interface may be configured to allow a user to input a value for a parameter, for example, text box 548 may be configured to allow a user to enter a value for AADT which is a local condition. Other parameters may be obtained from a memory or external server and the text boxes may be configured to not allow the value to be entered or changed. For example, text box 550 include the length of the segment 538 as an assumed value, and the text boxes 552 and 554 for the first 540 and second 542 regression coefficients include data from an appropriate table in the HSM (e.g., retrieved from an external server 108). The user interface 118 of FIG. 5B may also include an output 544, for example, a predicted crash frequency (N_{brmv}) 546, 556 from application of the SPF 532 to the 3T facility for multi-vehicle non-driveway collisions 520.

In FIG. 5C, the user interface 118 includes a plurality of text boxes for input (e.g., received from a user) and for other data associated with the proposed facility (3T) (e.g., received from a memory or external server). The data in the user interface of FIG. 5C is directed to a multi-vehicle driveway-related crash type 560. An SPF 562 (N_{brdwy}) for the crash type is also shown. In this example, the input parameters 564 for the example SPF 562 include a number of driveways (nᵢ) within the roadway segment of driveway type i including all driveways on both sides of the road 466, a driveway type (i) 568, a number (Nᵢ) of driveway related collisions per driveway per year for driveway type i 570, AADT 572, and a coefficient (t) of traffic volume adjustment 574. As shown in FIG. 5C, data for each roadway type i (e.g., major commercial, minor commercial, major industrial/Institutional, major residential, etc.) may be included in the user interface for the facility type (3T). The user interface may be configured to allow a user to input a value for a parameter, for example, text box 576 may be configured to allow a user to enter a value for the number of driveways which is a local condition, box 578 may be configured as a drop down menu to allow a user to select a driveway type, and text box 582 may be configured to allow a user to enter a value for AADT which is a local condition. Other parameters may be obtained from a memory or external server and the text boxes may be configured to not allow the value to be entered or changed. For example, text box 580 and text box 484 include data from an appropriate table in the HSM (e.g., received from an external server 108). The user interface 118 of FIG. 5C may also include an output 586, for example, a predicted crash frequency (N_{brdwy}) 588 from application of the SPF 562 to the 3T facility for multi-vehicle driveway-related collisions 560.

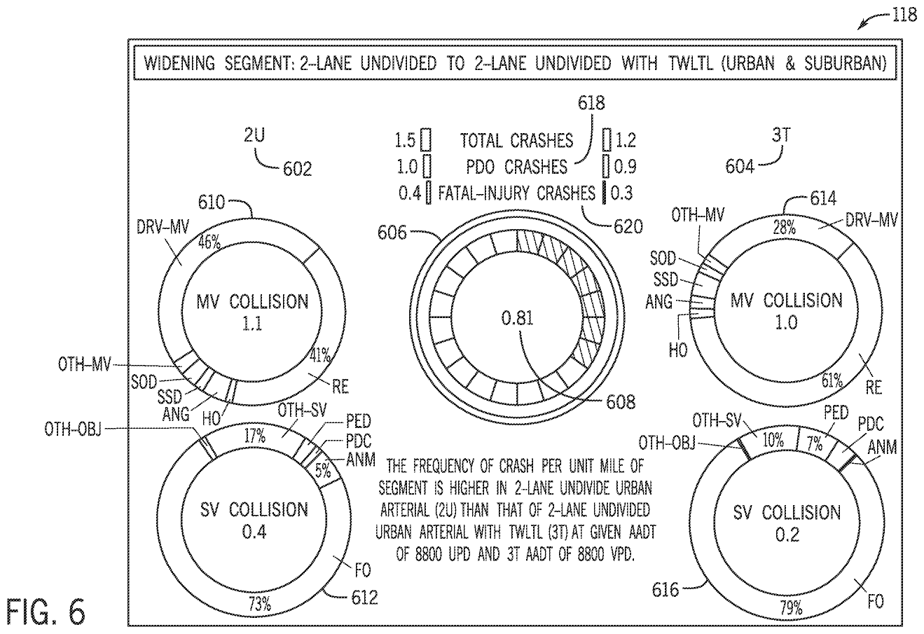

FIG. 6 illustrates an example user interface of a predictive safety assessment tool, the user interface providing a dashboard for output information according to various embodiments of the present disclosure. In some embodiments, FIG. 6 illustrates an example of a user interface 118 rendered in the networked environment of FIG. 1 according to various example embodiments of the present disclosure. The user interface 118 shown in FIG. 6 can, for example, be rendered on the display 121 of the computing device 106b (FIG. 1). FIG. 6 shows an example user interface 118 that is a dashboard associated with a roadway widening of a segment of a roadway defined within the segment data 124 that is a 2-lane undivided (2U) roadway segment. In this example, the proposed facility 130 is a 2-lane undivided with left-turn lane (TWLTL) (3T) roadway segment. In FIG. 6, crash data for the existing facility 2U 602 and the proposed facility 3T 604 can be compared. In this example, the user interface 118 includes a conversion factor 608 and a graphical representation 606 of the conversion factor for the proposed 3T facility 604. In addition, on the right side of the example user interface 118, crash data for the 2U facility 602 is illustrated graphically by crash type, for example, types of multi-vehicle (MV) collision 610 and types of single-vehicle (SV) collision 612. On the left side of the example user interface 118 crash data for the prosed 3T facility 604 is illustrated graphically by crash type, for example, types of multi-vehicle (MV) collision 614 and types of single-vehicle (SV) collision 616. Crash information based on severity (e.g., property damage only (PDO) crashes 618 and fatal-injury crashes 620) is also provided in the example user interface 118.

FIGS. 7A-7D illustrate example user interfaces of a predictive safety assessment tool, the use interfaces providing sensitivity analysis according to various embodiments of the present disclosure. In some embodiments, FIGS. 7A-7D illustrate examples of a user interface 118 rendered in the networked environment of FIG. 1 according to various example embodiments of the present disclosure. Any of the user interfaces 118 shown in FIGS. 7A-7D can, for example, be rendered on the display 121 of the computing device 106b (FIG. 1). FIG. 7A shows an example sensitivity analysis user interface 118 that is associated with a roadway widening of a segment of a roadway defined within the segment data 124 that is a 2-lane undivided (2U) roadway segment. In this example, the proposed facility 130 is a 2-lane undivided with left-turn lane (TWLTL) (3T) roadway segment. In FIG. 7A, the user interface 118 graphically depicts (e.g., a line graph) the predicted number of crashes per year (crash frequency) for the 2U facility 702 and the predicted number of crashes per year (crash frequency) for the proposed 3T facility 704. In this example, the use interface 118 also includes a plurality of check boxes 706 that allow a user to select a specific crash type (e.g., multi-vehicle only (MV Only), multi-vehicle driveway (MV_DRVY), single-vehicle only (SV Only), vehicle-pedestrian (VEH_PED), vehicle-bicycle (VEH_BIKE), total crashes (TOTAL)) to view. In FIG. 7A, the check box for total crashes 708 is selected. A slide or bar user interface element 710 can be provided and associated with the 2U facility and a slide or bar user interface element 712 can be provided and associated with the proposed 3T facility. Each of the slide (or bar) elements 710 and 712 can be configured to allow a user to adjust the traffic volume (e.g., AADT) for the respective facility which can result in an adjustment of the graphical representation 702, 704 of the crashes per year for the respective facility. The adjustment of the graphical representations 702, 704 of the crashes per year for each facility using traffic volume is discussed further below with respect to FIGS. 10A and 10B.

FIG. 7B shows an example sensitivity analysis user interface 118 that is associated with a roadway widening of a segment of a roadway defined within the segment data 124 that is a 2-lane undivided (2U) roadway segment. Similar to the embodiments in FIG. 7A, the proposed facility 130 is a 2-lane undivided with left-turn lane (TWLTL) (3T) roadway segment. In FIG. 7B, the user interface 118 graphically depicts (e.g., a line graph) the predicted number of crashes per year (crash frequency) for the 2U facility 702 and the predicted number of crashes per year (crash frequency) for the proposed 3T facility 704. In this example, each one of the a plurality of check boxes 706 is selected (e.g., check boxes 708 720, 722, 724, 726, and 728) to cause the predicted safety assessment tool to create a bar graph or chart 730 of the distribution of crashes by the crash type (e.g., multi-vehicle only (MV Only), multi-vehicle driveway (MV_DRVY), single-vehicle only (SV Only), vehicle-pedestrian (VEH_PED), vehicle-bicycle (VEH_BIKE), total crashes (TOTAL)) corresponding to the predicted crash per year depicted in the graphical representations 702 of the 2U facility and the graphical representation 704 of the 3T facility.

FIG. 7C shows an example sensitivity analysis user interface 118 that is associated with a roadway widening of a segment of a roadway defined within the segment data 124 that is a 2-lane undivided (2U) roadway segment. Similar to the embodiments in FIGS. 7A and 7B, the proposed facility 130 is a 2-lane undivided with left-turn lane (TWLTL) (3T) roadway segment. In FIG. 7C, the user interface 118 includes a graphical representation (e.g., a line graph) 740 (e.g., the graphical representation of FIG. 7A) of the predicted number of crashes per year (crash frequency) for the 2U facility and the predicted number of crashes per year (crash frequency) for the proposed 3T facility. In addition, in this example, the user interface 118 can also include a graphical representation 742 of the conversion from a 2U facility and a 3T facility. In some embodiments, the user interface includes an indication 744 of the amount of decrease in crashes e.g., 20%) for the proposed 3T facility compared to the 2U facility.

FIG. 7D shows an example sensitivity analysis user interface 118 that is associated with a roadway widening of a segment of a roadway defined within the segment data 124 that is a 4-lane undivided (4U) roadway segment. In the example of FIG. 7D, the proposed facility 130 is a 4-lane divided (4D) roadway segment. In FIG. 7D, the user interface 118 includes a graphical representation (e.g., a line graph) 750 of the predicted number of crashes per year (crash frequency) for the 4U facility and the predicted number of crashes per year (crash frequency) for the proposed 4D facility. In addition, in this example, the user interface 118 can also include a graphical representation 752 of the conversion from a 4U facility and a 4D facility. In some embodiments, the user interface includes an indication 754 of the amount of decrease in crashes e.g., 80%) for the proposed 4D facility compared to the 4 U facility.

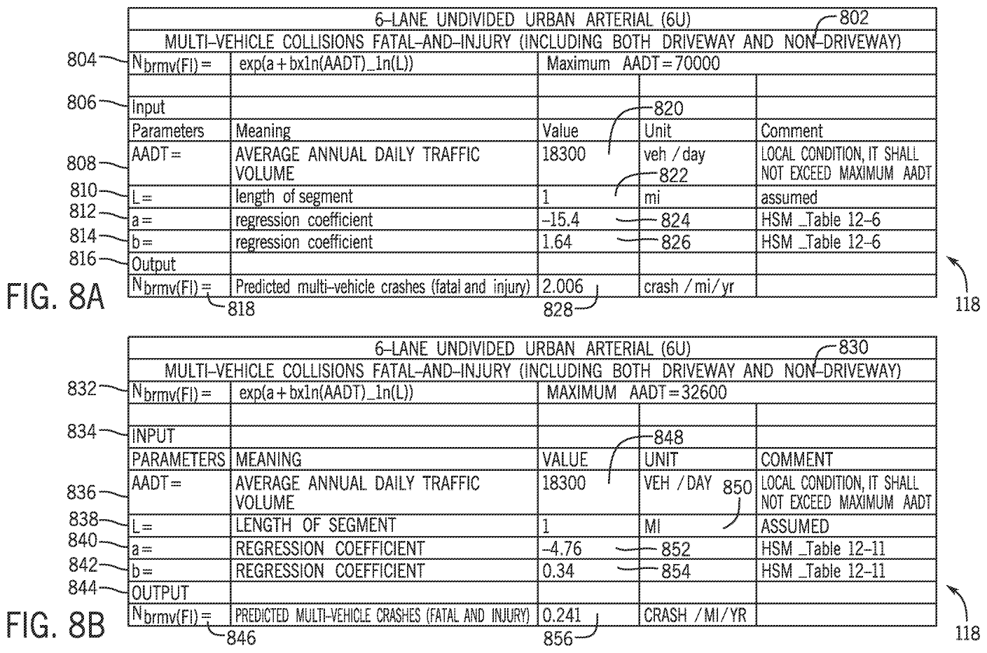

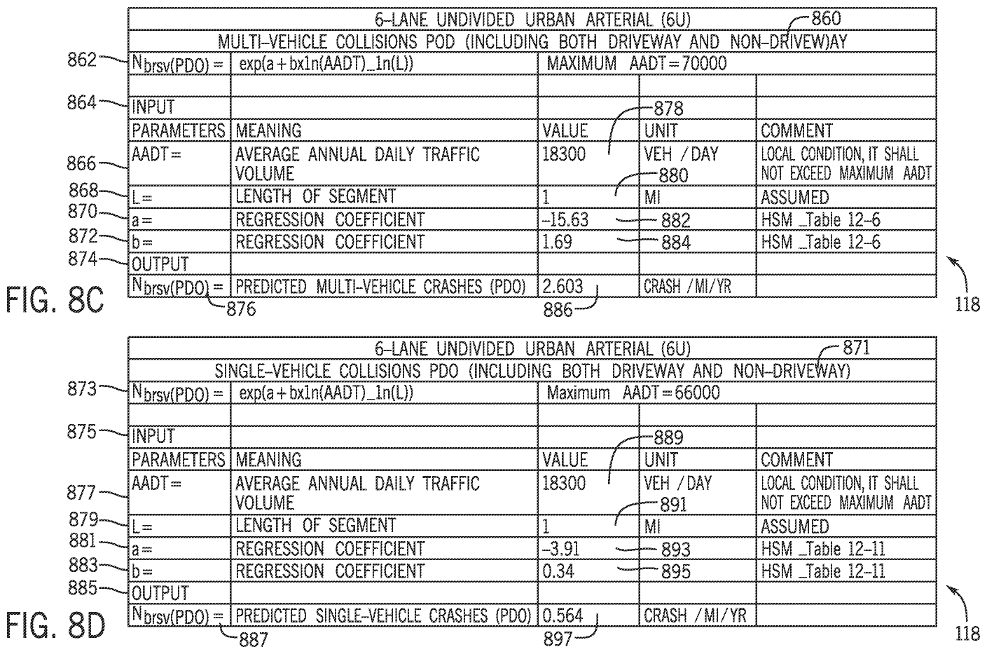

FIGS. 8A-8D illustrate example user interfaces of a predictive safety assessment tool, the user interfaces configured for receiving user input regarding at least one proposed facility according to various embodiments of the present disclosure. In some embodiments, FIGS. 8A-8D illustrate examples of a user interface 118 rendered in the networked environment of FIG. 1 according to various example embodiments of the present disclosure. Any of the user interfaces 118 shown in FIGS. 8A-8D can, for example, be rendered on the display 121 of the computing device 106b (FIG. 1). In some embodiments, the example user interfaces 118 shown in FIGS. 8A-8D may be combined and shown as a single user interface (e.g., a single worksheet) but are shown separately for simplicity and clarity.

FIGS. 8A-8D can be seen as examples of the predictive safety assessment tool 115 generating a portion of the user interface 118 that is an input sheet configured to obtain user input about an existing facility. The examples of FIGS. 8A-8D are directed to a proposed 6-Lane Undivided Facility (6U). The examples user interfaces 118 in FIGS. 8A and 8B are also directed to an analysis of a fatal-injury crashes and the example user interfaces 118 in FIGS. 8C and 8D are also directed to an analysis of a property damage only (PDO) crashes. In FIG. 8A, the user interface 118 (e.g., an input sheet) includes a plurality of text boxes for input (e.g. received from a user) and for other data associated with the proposed facility (6U) (e.g., received from a memory or external server). The data in the user interface of FIG. 8A is directed to a multi-vehicle fatal-and-injury (including both driveway and non-driveway) crash type 802. An SPF 804 (N_{brmvFI}) for the crash type is also shown. In this example, the input parameters 806 for the example SPF 804 include AADT 808, a length of a segment (L) 810, a first regression coefficient (a) 812, and a second regression coefficient (b) 814. The user interface may be configured to allow a user to input a value for a parameter, for example, text box 820 may be configured to allow a user to enter a value for AADT which is a local condition. Other parameters may be obtained from a memory or external server and the text boxes may be configured to not allow the value to be entered or changed. For example, text box 822 include the length of the segment 810 as an assumed value, and the text boxes 824 and 826 for the first 812 and second 814 regression coefficients include data from an appropriate table in the HSM (e.g., retrieved from an external server 108). The user interface 118 of FIG. 8A may also include an output 816, for example, a predicted crash frequency (N_{brmvFI}) 818, 828 from application of the SPF 804 to the 6U facility for multi-vehicle fatal-and-injury (including both driveway and non-driveway) collisions 802.

In FIG. 8B, the user interface 118 includes a plurality of text boxes for input (e.g., received from a user) and for other data associated with the proposed 6U facility (e.g., received from a memory or external server). The data in the user interface of FIG. 8B is directed to a single-vehicle fatal-and-injury (including both driveway and non-driveway) crash type 830. An SPF 832 (N_{brsvFI}) for the crash type is also shown. In this example, the input parameters 834 for the example SPF 832 include AADT 836, a length of a segment (L) 838, a first regression coefficient (a) 840, and a second regression coefficient (b) 842. The user interface may be configured to allow a user to input a value for a parameter, for example, text box 848 may be configured to allow a user to enter a value for AADT which is a local condition. Other parameters may be obtained from a memory or external server and the text boxes may be configured to not allow the value to be entered or changed. For example, text box 850 include the length of the segment 838 as an assumed value, and the text boxes 852 and 854 for the first 840 and second 842 regression coefficients include data from an appropriate table in the HSM (e.g., retrieved from an external server 108). The user interface 118 of FIG. 8B may also include an output 844, for example, a predicted crash frequency (N_{brmvFI}) 846, 856 from application of the SPF 832 to the 6U facility for single-vehicle fatal-and-injury (including both driveway and non-driveway) collisions 830.

In FIG. 8C, the user interface 118 (e.g., an input sheet) includes a plurality of text boxes for input (e.g., received from a user) and for other data associated with the proposed facility (6U) (e.g., received from a memory or external server). The data in the user interface of FIG. 8C is directed to a multi-vehicle PDO (including both driveway and non-driveway) crash type 860. An SPF 862 (N_{brmvPDO}) for the crash type is also shown. In this example, the input parameters 864 for the example SPF 862 include AADT 866, a length of a segment (L) 868, a first regression coefficient (a) 870, and a second regression coefficient (b) 872. The user interface may be configured to allow a user to input a value for a parameter, for example, text box 878 may be configured to allow a user to enter a value for AADT which is a local condition. Other parameters may be obtained from a memory or external server and the text boxes may be configured to not allow the value to be entered or changed. For example, text box 880 include the length of the segment 868 as an assumed value, and the text boxes 882 and 884 for the first 870 and second 872 regression coefficients include data from an appropriate table in the HSM (e.g., retrieved from an external server 108). The user interface 118 of FIG. 8C may also include an output 874, for example, a predicted crash frequency (N_{brmvPDO}) 876, 886 from application of the SPF 862 to the 6U facility for multi-vehicle PDO (including both driveway and non-driveway) collisions 860.

In FIG. 8D, the user interface 118 includes a plurality of text boxes for input (e.g., received from a user) and for other data associated with the proposed 6U facility (e.g., received from a memory or external server). The data in the user interface of FIG. 8D is directed to a single-vehicle PDO (including both driveway and non-driveway) crash type 871. An SPF 873 (N_{brsvPDO}) for the crash type is also shown. In this example, the input parameters 875 for the example SPF 873 include AADT 877, a length of a segment (L) 879, a first regression coefficient (a) 881, and a second regression coefficient (b) 883. The user interface may be configured to allow a user to input a value for a parameter, for example, text box 889 may be configured to allow a user to enter a value for AADT which is a local condition. Other parameters may be obtained from a memory or external server and the text boxes may be configured to not allow the value to be entered or changed. For example, text box 891 include the length of the segment 879 as an assumed value, and the text boxes 893 and 895 for the first 881 and second 883 regression coefficients include data from an appropriate table in the HSM (e.g., retrieved from an external server 108). The user interface 118 of FIG. 8D may also include an output 885, for example, a predicted crash frequency (N_{brmvPDO}) 887, 897 from application of the SPF 873 to the 6U facility for single-vehicle PDO (including both driveway and non-driveway) collisions 871.

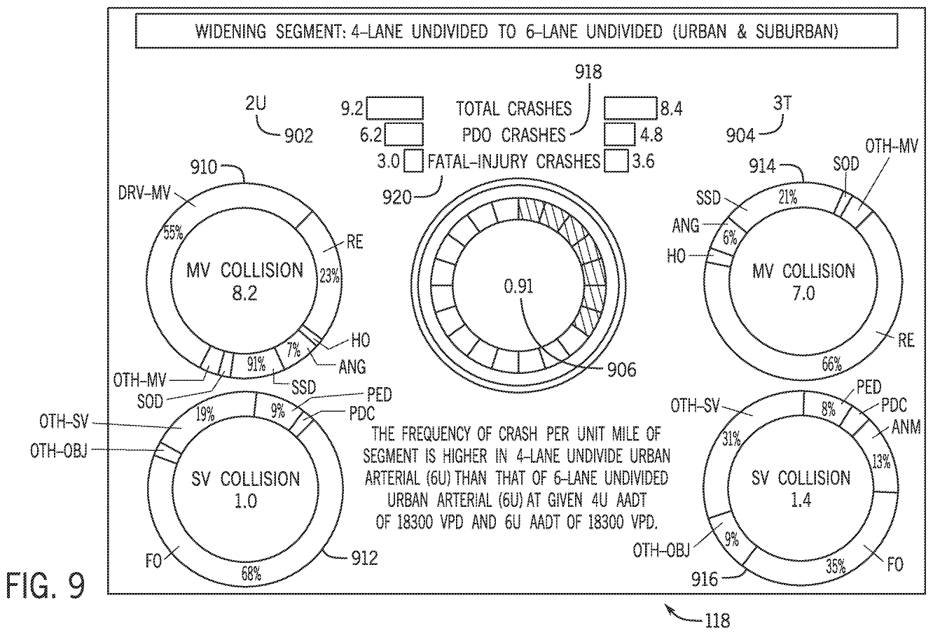

FIG. 9 illustrates an example user interface of a predictive safety assessment tool, the user interface providing a dashboard for output information according to various embodiments of the present disclosure. In some embodiments, FIG. 9 illustrates an example of a user interface 118 rendered in the networked environment of FIG. 1 according to various example embodiments of the present disclosure. Any of the user interfaces 118 shown in FIG. 9 can, for example, be rendered on the display 121 of the computing device 106b (FIG. 1). FIG. 9 shows an example user interface 118 that is a dashboard associated with a roadway widening of a segment of a roadway defined within the segment data 124 that is a 4-lane undivided (4U) roadway segment. In this example, the proposed facility 130 is a 6-lane undivided (6U) roadway segment. In FIG. 9, crash data for the existing facility 4U 902 and the proposed 3T facility 904 can be compared. In this example, the user interface 118 includes a conversion factor 906 and a graphical representation 908 of the conversion factor for the proposed 3T facility 904. In addition, on the right side of the example user interface 118, crash data for the 2U facility 902 is illustrated graphically by crash type, for example, types of multi-vehicle (MV) collision 910 and types of single-vehicle (SV) collision 912. On the left side of the example user interface 118 crash data for the prosed 3T facility 904 is illustrated graphically by crash type, for example, types of multi-vehicle (MV) collision 914 and types of single-vehicle (SV) collision 916. Crash information based on severity (e.g., property damage only (PDO) crashes 918 and fatal-injury crashes 920) is also provided in the example user interface 118.

FIGS. 10A-10C illustrate example user interfaces of a predictive safety assessment tool, the use interfaces providing sensitivity analysis according to various embodiments of the present disclosure. In some embodiments, FIGS. 10A-10C illustrate examples of a user interface 118 rendered in the networked environment of FIG. 1 according to various example embodiments of the present disclosure. Any of the user interfaces 118 shown in FIGS. 10A-10C can, for example, be rendered on the display 121 of the computing device 106b (FIG. 1). The example of FIGS. 10A and 10B illustrate an example of a user interface 118 that is a sensitivity analysis having one or more user interface elements for altering an annual average daily traffic (AADT) associated with at least one of: (1) the at least one of the plurality of proposed facilities 130 or (2) the at least one existing facilities

FIG. 10A shows an example sensitivity analysis user interface 118 that is associated with a roadway widening of a segment of a roadway defined within the segment data 124 that is a 4-lane undivided (4U) roadway segment. In this example, the proposed facility 130 is a 6-lane undivided (6U) roadway segment. In FIG. 10A, the user interface 118 graphically depicts (e.g., a line graph) the predicted number of crashes per year (crash frequency) for the 4U facility 1002 and the predicted number of crashes per year (crash frequency) for the proposed 6U facility 1004. In this example, the use interface 118 also includes a plurality of check boxes 1006 that allow a user to select a specific crash type (e.g., multi-vehicle only (MV Only), multi-vehicle driveway (MV_DRVY), single-vehicle only (SV Only), vehicle-pedestrian (VEH_PED), vehicle-bicycle (VEH_BIKE), total crashes (TOTAL)) to view. In FIG. 10A, the check box for total crashes 1008 is selected. A slide or bar user interface element 1010 can be provided and associated with the 4U facility and a slide or bar user interface element 1012 can be provided and associated with the proposed 6U facility. Each of the slide (or bar) elements 1010 and 1012 can be configured to allow a user to adjust the traffic volume (e.g., AADT) for the respective facility which can result in an adjustment of the graphical representation (e.g., line graphs) 1002, 1004 of the crashes per year for the respective facility. FIG. 10B illustrates the user interface 1018 of FIG. 10A after each of the slide (or bar) elements 1010 and 1012 for the 4U 1002 and 6U 1004 facilities, respectively, have been adjusted to increase the AADT. As a result, the predictive safety assessment tool 115 determines new predicted crash frequencies for the 4U 1002 and the 6U 1004 facilities based the increased traffic volume and generates a new line graph reflected the adjusted predicted crash frequency values.

FIG. 10C shows an example sensitivity analysis user interface 118 that is associated with a roadway widening of a segment of a roadway defined within the segment data 124 that is a 6-lane undivided (6U) roadway segment. The proposed facility 130 is a 6-lane divided (6D) roadway segment. In FIG. 10C, the user interface 118 graphically depicts (e.g., a line graph) the predicted number of crashes per year (crash frequency) for the 6U facility 1020 and the predicted number of crashes per year (crash frequency) for the proposed 6D facility 1022. In this example, each one of a plurality of check boxes 1024 is selected (e.g., check boxes 1026, 1028, 1030, 1032, 1034, and 1036) to cause the predicted safety assessment tool 115 to create a bar graph or chart 1036 of the distribution of crashes by the crash type (e.g., multi-vehicle only (MV Only), multi-vehicle driveway (MV_DRVY), single-vehicle only (SV Only), vehicle-pedestrian (VEH_PED), vehicle-bicycle (VEH_BIKE), total crashes (TOTAL)) corresponding to the predicted crash per year depicted in the graphical representations 1020 of the 6U facility and the graphical representation 1022 of the proposed 6D facility.

Although the predictive safety assessment tool 115 and other various systems described herein may be embodied in software or codes executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuit (ASICs) having appropriate logic gates, field-programmable gate arrays (FPGAs), or other components, etc. Such technologies are generally well known to those skilled in the art and, consequently, are not described in detail herein.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and X,” unless specifically stated otherwise, is to be understood that an item, term, etc., can be either X, Y, and Z, or any combination thereof (e.g., X, Y, and/or Z). Thus, as used herein, such phrases are not generally intended to, and should not, imply that certain embodiments require at least one of either X, Y, or Z to be present, but not, for example, one X and one Y. Further, such phrases should not imply that certain embodiments require each of at least one of X, at least one of Y, and at least one of Z to be present.

Although embodiments have been described herein in detail, the descriptions are by way of example. The features of the embodiment described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded to the broadest interpretation so as to encompass modifications and equivalent structures.

What is claimed is:

1. A method for generating a predictive safety assessment of at least one existing facility and at least one proposed facility, the method comprising:
obtaining, via at least one computing device, data about an existing facility, the data comprising segment data and intersection data;
obtaining, via the at least one computing device, data about at least one proposed facility, the data comprising segment data and the intersection data;
receiving, via the at least one computer device, user input data regarding at least one local condition for the existing facility and the at least one proposed facility;
determining, via the at least one computing device, a predicted crash frequency for the existing facility based at least on a set of Safety Performance Functions (SPFs) associated with a facility type for the existing facility;
determining, via the at least one computing device, a predicted crash frequency for the at least one proposed facility based at least on a set of Safety Performance Functions (SPFs) associated with a facility type of the at least one proposed facility;
determining, via the at least one computing device, a conversion factor for each of the at least one proposed facility based on the predicted crash frequency of the existing facility and the predicted crash frequency of the at least one proposed facility;
determining, via the at least one computing device, a crash severity distribution by crash types;
determining, via the at least one computing device, an impact of local traffic volume for the at least one proposed facility; and
generating a user interface, via the at least one computing device, the user interface configured to render a graphical representation of at least each conversion factor for the at least one proposed facility.

2. The method according to claim 1, wherein determining the predicted crash frequency for the existing facility is further determined based on at least one crash modification factor (CMF).

3. The method according to claim 1, wherein determining the predicted crash frequency for the existing facility is further determined based on a local calibration factor by facility type and determining the predicted crash frequency for the at least one proposed facility is further determined based on a local calibration factor.

4. The method according to claim 1, wherein determining the predicted crash frequency for the at least one proposed facility is further determined based on at least one crash modification factor (CMF).

5. The method according to claim 1, wherein the crash types include one or more of rear-end collision, head-on collision, angle collision, sideswipe in same direction collision, sideswipe in opposite direction collision, animal collision, fixed-object collision, other object collision, pedestrian collision and pedal-cycle collision.

6. The method according to claim 1, wherein the predicted crash frequency for the at least one proposed facility is a predicted annual average crash frequency.

7. The method according to claim 6, wherein generating a user interface, via the at least one computing device, further includes generating a user interface comprising a dashboard for at least the at least one proposed facility, wherein the dashboard comprises the predicted annual average crash frequency.

8. The method according to claim 7, wherein the dashboard is configured to render at least one indication of the predicted crash frequency, an annual average daily traffic (AADT), a total number of crashes, a number of Property Damage Only (PDO) crashes, or a number of fatal-injury crashes for the at least one proposed facility.

9. The method according to claim 1, further comprising:
generating, via the at least one computing device, a user interface comprising a distribution of crashes by types and severity based at least in part on the crash severity distribution by crash types for the at least one proposed facility relative to the existing facility.

10. The method according to claim 1, further comprising:
generating, via the at least one computing device, a user interface comprising a sensitivity analysis for the at least one proposed facility.

11. The method according to claim 10, wherein the sensitivity analysis includes a comparison of a number of crashes for the at least one proposed facility and the existing facility based on the local traffic volume.

12. The method according to claim 11, wherein the user interface further comprises a user interface element for altering an annual average daily traffic (AADT) associated with at least one proposed facility or the existing facility.

13. A system for generating a predictive safety assessment of at least one existing facility and at least one proposed facility, the system comprising:
at least one processor; and
a non-transitory computer-readable medium in communication with the at least one processor, wherein the at least one processor is configured to execute instructions embodied on the computer-readable medium to perform operations comprising:
obtaining segment data and intersection data about an existing facility;
obtaining segment data and intersection data about at least one proposed facility;
rendering a first user interface configured to obtain user input about at least one local condition for the existing facility and the at least one proposed facility;
determining a predicted crash frequency for the existing facility based at least on a set of Safety Performance Functions (SPFs) associated with a facility type for the existing facility;
determining a predicted crash frequency for the at last one proposed facility based at least on set of Safety Performance Functions (SPFs) associated with a facility type for the at least one proposed facility;
determining a conversion factor for each of the at least one proposed facility based on the predicted crash frequency of the existing facility and the predicted crash frequency of the at least one proposed facility;
determining a crash severity distribution by crash types;
determining an impact of local traffic volume for the at least one proposed facility; and
rendering a second user interface configured to render a graphical representation of at least each conversion factor for the at least one proposed facility.

14. The system according to claim 13, wherein the first user input further comprises at least one of an average traffic, an annual average daily traffic (AADT), on-street parking, an average median width, a type of street lighting, a speed limit, a number of driveways, a driveway type, a distance of fixed objects, a density of fixed roadside objects, or other data about one or more segments of roadway associated with the at least one proposed facility.

15. The system according to claim 13, wherein determining the predicted crash frequency for the existing facility is further determined based on at least one crash modification factor (CMF) and determining the predicted crash frequency for the at least one facility is further determined based on at least one crash modification factor (CMF).

16. The system according to claim 13, wherein determining the predicted crash frequency for the existing facility is further determined based on at least one local calibration factor and wherein determining the predicted crash frequency for the at least one proposed facility is further determined based on at least one local calibration factor.

17. The system according to claim 13, wherein the predicted crash frequency for the at least one proposed facility is a predicted annual average crash frequency.

18. The system according to claim 17, wherein the second user interface further comprises a dashboard for at least the at least one proposed facility, wherein the dashboard comprises the predicted annual average crash frequency.

19. The system according to claim 17, wherein the dashboard is configured to render at least one indication of the predicted crash frequency, an annual average daily traffic (AADT), a total number of crashes, a number of Property Damage Only (PDO) crashes, or a number of fatal-injury crashes for the at least one proposed facility.

20. The system according to claim 13, wherein the second user interface further comprises a distribution of crashes by types and severity based at least in part on the crash severity distribution by crash types for the at least one proposed facility relative to the existing facility.
